(19) United States
(12) Patent Application Publication
(10) Pub. No.: US 2012/0331343 A1
(43) Pub. Date: Dec. 27, 2012

(54) APPARATUS AND METHOD FOR ELECTRONIC DEVICE TESTING

(75) Inventors: Benjamin E. Norton, San Francisco, CA (US); Andrei V. Izotov, San Diego, CA (US)

(73) Assignee: QUALCOMM INCORPORATED, San Diego, CA (US)

(21) Appl. No.: 13/167,661

(22) Filed: Jun. 23, 2011

(51) Int. Cl. G06F 11/00

(52) U.S. Cl. 714/25; 714/E11.018

(57) ABSTRACT

A procedure for testing an electronic device is disclosed. A computer bundles into command groups multiple test and wait commands of a test sequence. Each command group is sent to the device, reducing the per-message latency of the command transfers. The commands are queued and stored in the device. The wait commands define the timeline of the tests to be executed on the device. For example, each wait command forces a wait state of a length corresponding to the parameter of the wait command. The length of the wait state is measured from the beginning of the test sequence or the completion of the previous wait command. The wait state associated with each wait command may be made longer than the combined conservative estimates of time periods required for executing all the test commands between a previous point in time defined in the test sequence and the current wait command.

### BACKGROUND

1. Field

The present invention relates generally to testing of electronic circuits. More particularly, in aspects the invention relates to test command execution and timeline control in the course of factory testing of circuits installed in electronic devices.

2. Background

Electronic component circuits are often tested when manufactured as well as after their inclusion in a complete device or a larger component device. For example, radio frequency (RF) application specific integrated circuits (ASICs) of cellular telephones and similar mobile devices may be tested when the ASICs are fabricated, and then again after they are installed in a mobile device. Often, performance of every mobile device is tested in the course of production, including those parts of its performance that depend on the RF ASICs.

Test equipment used in such testing may include signal generators for stimulating the mobile devices, and signal analyzers for recording and analyzing RF transmissions of the mobile devices. Data from registers and other memory locations of the mobile devices may be read as part of such testing.

During chip fabrication, testing is facilitated by easy access to the chip's pins, solder balls, or other electrical interfaces; in other words, there are no serious barriers to connecting high speed buses to drive and read the chip directly. This is a different paradigm from testing the chip after installation within a larger device, such a mobile device, where direct access to the chip's pins is unavailable. In the latter case, access to the chip may be available through a relatively high-latency interface. Today, most cellular telephones include Universal Serial Bus (USB) interfaces, which can be used to access and test circuits internal to the mobile devices, including RF ASICs.

Because testing is time-sensitive, the state (configuration) of the mobile device has to be known at precise points in times. For example, an external test setup may need to know when a particular RF transmission emanates from a mobile device, to measure and compare the RF transmission to the expected waveform. Similarly, the test equipment of the setup may need to stimulate a mobile device with an external waveform and simultaneously read the mobile device's internal response to the stimulus. Clearly, knowledge of the mobile device's timing is important. Therefore, there is a need in the art for apparatus and methods that provide improved knowledge of electronic device state during testing, and for increased precision in controlling and defining internal timing of electronic devices during testing.

Per-unit cost of mass-produced electronic devices depends in part on the time consumed by testing each unit. Because serial port latency can range from 1 ms to be about 50 ms per synchronous message write/read, sending a large number of individual messages to an electronic device to test its internal chips may unduly lengthen per-device test times. A need in the art exists for techniques that lower the per-unit testing times.

### SUMMARY

Embodiments disclosed herein may address the above stated needs by enabling execution according to a predefined timeline, during testing of electronic products, such as testing of RF performance in mobile phone factories. In aspects, this is achieved by sending groups of a variable number of individual commands for storage in a mobile device, so that the timing on the mobile device can be used to execute the stored commands in a predefined order and in accordance with the predefined timeline. The stored commands may define the timeline. The precision and time-resolution of the timing of the tests of the mobile device are improved. In aspects, asynchronous reports relating to the tests are received from the mobile device.

In an embodiment, a method of testing an electronic device has a number of steps. The steps include a step of sending to the electronic device a test sequence of the electronic device. The test sequence includes a plurality of N test commands CTEST[i], 1≦i≦N, and one or more timeline definition commands CWAIT[j], 1≦j≦M, M being one or more. The one or more timeline definition commands define a timeline for executing the test sequence. The steps also include transferring to the electronic device an instruction to execute the test sequence. The steps further include configuring the electronic device to:

(a) receive the plurality of N test commands and the one or more timeline definition commands,

(b) queue in order the plurality of N test commands and the one or more timeline definition commands received by the electronic device, to obtain a queue of commands,

(c) abstain from executing the queue of commands until the electronic device receives the instruction to execute the test sequence,

(d) when executing the queue of commands, execute each timeline definition command CWAIT[j] by preventing execution of the test command immediately following said each timeline definition command CWAIT[j] until a time t[j] associated with said each timeline definition command CWAIT[j], the time t[j] being defined by expiration of a period p[j] associated with said each timeline definition command CWAIT[j], a length L[j] of the period p[j] being defined by said each timeline definition command CWAIT[j], the period p[j] for the earliest timeline definition command in the queue starting at system time at the beginning of execution of the test sequence, the period p[j] for all timeline definition commands in the queue other than the earliest timeline definition command in the queue starting at a time t[j−1] associated with timeline definition command CWAIT[j−1] that immediately precedes said each timeline definition command CWAIT[j],

(e) receive the instruction, and

(f) in response to receiving the instruction, execute the queue of commands in order and according to the timeline.

In an embodiment, a method of testing an electronic device includes a step for sending to the electronic device a test sequence of the electronic device. The method also includes, after the step for sending, triggering transferring execution of the test sequence. The method further includes a step for executing the test sequence in accordance with a predefined timeline.

In an embodiment, an electronic device is configured to receive a test sequence of the electronic device. The test sequence includes a plurality of N test commands CTEST[i], 1≦i≦N, and one or more timeline definition commands CWAIT[j], 1≦j≦M, M being one or more. The one or more timeline definition commands define a timeline for executing the test sequence. The electronic device is also configured to receive an instruction to execute the test sequence, after receiving all steps of the test sequence. The electronic device is further configured to queue in order the plurality of N test commands and the one or more timeline definition commands received by the electronic device, to obtain a queue of commands. The electronic device is further configured to abstain from executing the queue of commands until the electronic device receives an instruction to execute the test sequence. The electronic device is further configured, when executing the queue of commands, to execute each timeline definition command CWAIT[j] by preventing execution of the test command immediately following said each timeline definition command CWAIT[j] until a time t[j] associated with said each timeline definition command CWAIT[j]. The time t[j] is defined by expiration of a period p[j] associated with said each timeline definition command CWAIT[j]. A length L[j] of the period p[j] is defined by said each timeline definition command CWAIT[j]. The period p[j] starts at the later of: (1) system time at the beginning of execution of the test sequence, and (2) time t[j−1] associated with timeline definition command CWAIT[j−1] that immediately precedes said each timeline definition command CWAIT[j]. The electronic device is further configured to receive the instruction to execute the test sequence. The electronic device is further configured to execute the queue of commands in order and according to the timeline, in response to receipt of the instruction.

In an embodiment, an article of manufacture has at least one machine readable medium storing instructions for configuring an electronic device to:

(a) receive a test sequence of the electronic device, the test sequence comprising a plurality of N test commands CTEST[i], 1≦i≦N, and one or more timeline definition commands CWAIT[j], 1≦j≦M, M being one or more, the one or more timeline definition commands defining a timeline for executing the test sequence;

(b) queue in order the plurality of N test commands and the one or more timeline definition commands received by the electronic, to obtain a queue of commands;

(c) when executing the queue of commands, execute each timeline definition command CWAIT[j] by preventing execution of the test command immediately following said each timeline definition command CWAIT[j] until a time t[j] associated with said each timeline definition command CWAIT[j], the time t[j] being defined by expiration of a period p[j] associated with said each timeline definition command CWAIT[j], a length L[j] of the period p[j] being defined by said each timeline definition command CWAIT[j], the period p[j] for the earliest timeline definition command in the queue starting at system time at the beginning of execution of the test sequence, the period p[j] for all timeline definition commands in the queue other than the earliest timeline definition command in the queue beginning at a time t[j−1] associated with timeline definition command CWAIT[j−1] that immediately precedes said each timeline definition command CWAIT[j]; and

(d) after receiving and queueing all commands of the test sequence, execute the queue of commands in order and according to the timeline.

In an embodiment, an electronic device includes means for receiving a test sequence of the electronic device. The test sequence has a plurality of N test commands CTEST[i], 1≦i≦N, and one or more timeline definition commands CWAIT[j], 1≦j≦M, M being one or more. The one or more timeline definition commands define a timeline for executing the test sequence. The electronic device also includes a means for queueing in order the plurality of N test commands and the one or more timeline definition commands received by the electronic device, to obtain a queue of commands. The electronic device further includes a means for executing each timeline definition command CWAIT[j] by preventing execution of the test command immediately following said each timeline definition command CWAIT[j] until a time t[j] associated with said each timeline definition command CWAIT[j]. The time t[j] is defined by expiration of a period p[j] associated with said each timeline definition command CWAIT[j]. A length L[j] of the period p[j] is defined by said each timeline definition command CWAIT[j]. The period p[j] for the earliest timeline definition command in the queue starts substantially at system time at the beginning of execution of the test sequence. The period p[j] for all timeline definition commands in the queue other than the earliest timeline definition command in the queue starts substantially at a time t[j−1] associated with timeline definition command CWAIT[j−1] that immediately precedes said each timeline definition command CWAIT[j]. The electronic device further includes a means for executing the queue of commands in order and according to the timeline, in response to receipt of an instruction to execute the test sequence, after receiving and queueing the test sequence.

Further scope of the applicability of the present methods, apparatus, and articles of manufacture will become apparent from the detailed description, claim(s), and drawings. It should be understood, however, that the detailed description and specific examples, while indicating one or more preferred embodiments, are given by way of illustration only, since various changes and modifications within the spirit and scope of the invention will become apparent to those skilled in the art.

### BRIEF DESCRIPTION OF THE DRAWINGS

FIG. 1 illustrates selected components of a test setup for testing an electronic device;

FIG. 2 illustrates selected aspects of timeline definition and control in testing the electronic device; and

FIG. 3 illustrates selected steps of a process for testing the electronic device.

### DETAILED DESCRIPTION

The detailed description set forth below in connection with the appended drawings is intended as a description of exemplary embodiments and is not intended to represent the only embodiments in which the present invention can be practiced. The detailed description includes several specific details for the purpose of providing a thorough understanding of the present invention. It will be apparent to those skilled in the art, however, that the present invention may be practiced without certain specific details. In some instances, well known structures and devices are shown in block diagram form in order to avoid obscuring the concepts of the present invention.

The words “embodiment,” “variant,” “implementation,” “example,” and similar expressions are used to refer to a particular apparatus, process, or article of manufacture, and not necessarily to the same apparatus, process, or article of manufacture. Thus, “one embodiment” (or a similar expression) used in one place or context may refer to a particular apparatus, process, or article of manufacture; the same or a similar expression in a different place may refer to a different apparatus, process, or article of manufacture. The expressions “alternative embodiment,” “alternatively,” and similar phrases may be used to indicate one of a number of different possible embodiments. The number of possible embodiments is not necessarily limited to two or any other quantity.

The word “exemplary” may be used herein to mean “serving as an example, instance, or illustration.” Any embodiment or variant described herein as “exemplary” is not necessarily to be construed as preferred or advantageous over other embodiments or variants. All of the embodiments and variants described in this document are exemplary embodiments and variants provided to enable persons skilled in the art to make and use the invention, and not necessarily to limit the scope of legal protection afforded the invention.

The terms “component,” “module,” “system,” “block,” and the like are intended to refer to a computer-related or other electronic entity, either hardware, software, firmware, or any combination of two or more of hardware, software, and firmware. For example, a block may be, but is not limited to being, a process running on a processor, a processor, an object, an executable, a thread of execution, a program, or a computer. One or more components may reside within a process or thread of execution and a component may be localized on one computer or distributed between or among two or more computers.

“Test” and “testing” refer to diagnostic procedures, performance verification procedures, calibration procedures, and similar/analogous procedures. As used below, these terms include testing on a device level, using a communication interface of the device. In selected embodiments, testing is performed on RF chips and chipsets of mobile devices, such as cellular telephones and similar cellular communication devices. For example, a cellular device's responses to RF stimuli at different frequencies and power levels may be tested, and the cellular device's RF responses may be calibrated to set the required cellular device transmit power levels under predefined conditions. Various measurements of signals received by the mobile device may be made, and the measured quantities may be read by a computer of a test setup used for testing of the device.

Thus, aspects disclosed herein include apparatus and methods for testing and analyzing electronic circuits (such as integrated circuits or ICs, ASICs, and chipsets) installed in larger components or complete devices. The apparatus and methods are discussed using RF circuits installed in mobile telephones and similar devices. More generally, the principles described in this document may be used for testing other components installed in or connected to various electronic devices, including audio devices, video devices, entertainment devices, WLAN devices, Bluetooth® devices, computers, and computer peripherals. This list is, of course, exemplary and not exclusive.

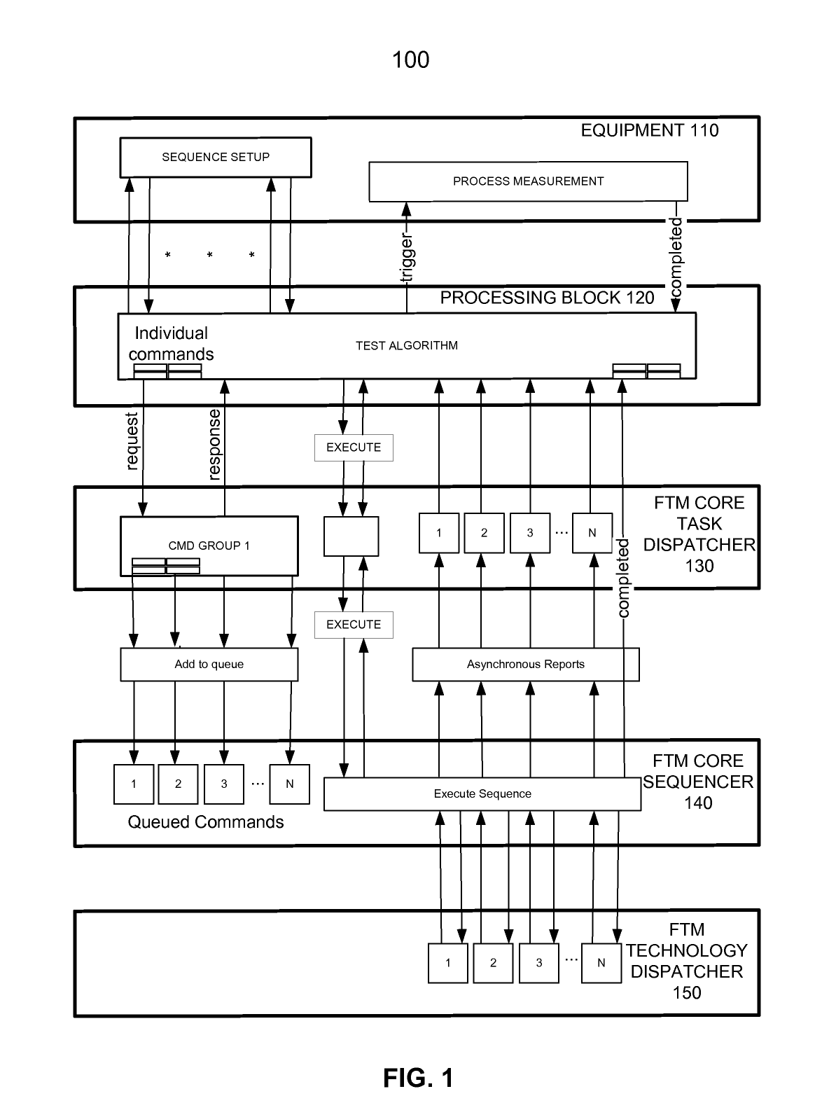

FIG. 1 illustrates selected blocks (hardware, software, firmware, mixed) of a test setup 100. The test setup 100 includes equipment 110, which is test equipment external to the device under test (DUT) being tested. For concreteness of the examples described, it is assumed that the DUT is a mobile device (e.g., a cellular telephone); the tests are performed on the RF chip set of the DUT; and the equipment 110 includes RF test generation and measurement instruments, such as RF signal generator(s) and/or RF signal analyzer(s). The equipment 110 may perform measurements on the DUT (e.g., RF transmitter), and/or may provide stimuli to the DUT receiver (e.g., feed RF waveforms to the DUT).

The test setup 100 also includes a processing block 120. This may be a personal computer, such as a Windows®, a Mac®, or a Linux machine, or another computer; it can also be two or more interconnected computers. The processing block 120 is connected to the DUT, enabling the processing device to send information (e.g., commands and command parameters) to the DUT, and to receive information (e.g., reports, measurements, and other responses) from the DUT. A test algorithm of the processing block 120 is configured to obtain individual test commands and to bundle the individual test commands into command groups, with each command group including a plurality of individual test commands. This addresses the need to reduce testing time by sending fewer messages to the DUT and therefore incur less message latency overhead during the entire test process.

The processing block 120 is also connected to the equipment 110, enabling the processing block 120 to configure the equipment 110, start/stop specific tests, measurements, calibration procedures, and/or verification procedures.

A Factory Test Mode (FTM) Core Task Dispatcher 130 is configured to receive command groups (i.e., the bundled individual commands) from the processing block 120, and send the commands to an FTM Core Sequencer 140. The FTM Core Task Dispatcher 130 may also receive diagnostic and other reports from the FTM Core Sequencer 140, and communicate the reports to the processing block 120. The interface between the FTM Core Task Dispatcher 130 and the processing block 120 may be a Universal Serial Bus (USB) interface. The FTM Core Sequencer 140 may be configured to perform one or more functions described below; for example, it may be configured to receive the commands and add the individual commands to a queue for further processing in a predefined order and according to a predefined timeline of execution. The order and the timeline, or portions of them, may be defined by the received commands.

An FTM Technology Dispatcher 150 is a technology specific message handler configured to take a message and call an appropriate driver or service within the DUT.

In a particular variant, the FTM Core Task Dispatcher 130, the FTM Core Sequencer 140, and the FTM Technology Dispatcher 150 are implemented in the DUT. But it should be understood that the boundaries shown in FIG. 1 are drawn for convenience of description, and may not necessarily correspond to the actual physical boundaries. Thus, the processing block 120 may logically constitute part of the equipment 110. Furthermore, certain functions described (explicitly or implicitly) as being performed by the processing block 120 may in fact be implemented in the FTM Core Task Dispatcher 130. The specific functionality within each block may be implemented in hardware, firmware, software, and/or combinations of them.

In operation, the test routines executing on processing block 120 bundle a large number of individual commands (which need to execute on the DUT) into command groups. The small individual commands typically range in size between 10 and 400 bytes, although this is not necessarily a limitation on all aspects of the processes and apparatus disclosed herein. The command groups are then sent to the DUT, for example, to the FTM Core Task Dispatcher executing on the DUT. Each of the command groups may constitute a single message. In this way, the per-command latency of the interface between the processing block 120 and the DUT is replaced with per command group latency, and the overall latency may be greatly reduced. For example, a high speed USB may transfer information at the rate of megabits per second, with the per-message latency (which may be between 1 ms and 50 ms) being incurred for the group commands instead of the much larger number of individual commands. In a variant, the size of each of the command groups does not exceed two kilobytes.

The FTM Core Task Dispatcher 130 receives the group commands, and transmits them (as group commands, as individual commands, or otherwise) to the FTM Core Sequencer 140, where the individual commands are queued for execution. The queued commands are shown as blocks 1, 2, 3, . . . N. The queue may contain any number of commands. Each command may be added to the queue when the command arrives; when execution is called later, the commands are executed in order. The queue may thus act as a first-in-first-out (FIFO) command buffer.

Because of possible limitations on the size of command groups, a test sequence may be defined (i.e., may include) two or more command groups that have to be sent to and stored in the DUT before a test sequence can be commenced. After the commands of a test sequence are queued, the commands reside in the DUT's storage, such as RAM or other memory. The DUT does not begin to execute the commands of the test sequence until it receives a separate instruction to execute the command queue or.

Transfer of additional commands or other messages to the DUT may be blocked when the test sequence is executed. This blockage of commands reduces disturbances to the DUT while tests are performed. In variants, only selected commands are blocked, or only selected commands are allowed to be transferred to the DUT while the tests are performed. For example, status queries my be allowed while all or selected other commands are blocked. “Lock down status” is used to refer to the status of the DUT when some commands are prevented from being received by the DUT.

Once the instruction to commence executing a test sequence is received or execution of the test sequence is otherwise triggered, the FTM Core Sequencer 140 executes (or causes to execute) the stored commands according to a predefined timeline. In other words, after one command is executed, the immediately following command is not necessarily executed right away; there may be a wait period between the commands. The timeline may be defined by some of the commands in the queue. In this way, timing relationships are established (1) between or among the commands, and (2) between or among particular commands and test procedures performed by the processing block 120 and the equipment 110.

The commands may include (1) test commands that relate to setting up the DUT and determining its state/configuration information, and (2) timeline definition and control commands. The test commands may include commands for setting up the DUT's transmitter to transmit predefined information at predefined frequencies and power levels, and to read the information from the DUT's receiver output at predefined times (or derived from the DUT's receiver output at predefined times). More generally, the FTM Core Sequencer 140 sends messages with the test commands (or equivalent information) to the FTM Technology Dispatcher 150 for execution. The FTM Technology Dispatcher 150 evaluates the messages from the FTM Core Sequencer 140, and sends corresponding function calls with parameter to the drivers and/or services appropriate for the test commands in the messages. For example, the FTM Technology Dispatcher 150 may call a GSM radio driver, a CDMA2000 radio driver, a digital signal processor (DSP), or other hardware registers.

As indicated by the up arrows from the FTM Technology Dispatcher 150 to the FTM Core Sequencer 140, the FTM Technology Dispatcher 150 may respond to each of the test commands with a report. The report may acknowledge the test command, and include a payload with additional information related to the execution of the test command. The additional information may be, for example, specific power levels measured by the radio receiver, time a specific test began, time a specific test completed, time overrun of a specific test, an indication that a test has been performed, an indication that a test passed, and a diagnostic report such as an error message. The information in the reports from the FTM Technology Dispatcher 150 (or portions of the information, or derivative information) may be transmitted from the FTM Core Sequencer 140 through the FTM Core Task Dispatcher 130 to the processing block 120. The processing block 120 may process the information as part of its test routines, for example, comparing the power levels sensed by the radio receiver to a range of acceptable power level values. Messages with information in the reports may be unblocked during test execution.

Reporting key timing parameters for individual commands allows the processing block 120 to look at the actual timeline of the testing in order to troubleshoot test procedures. For example, the processing block 120 can determine, based on the actual timeline, whether a specific wait time needs to be increased, or if a problem exists with a specific test that takes too long to complete.

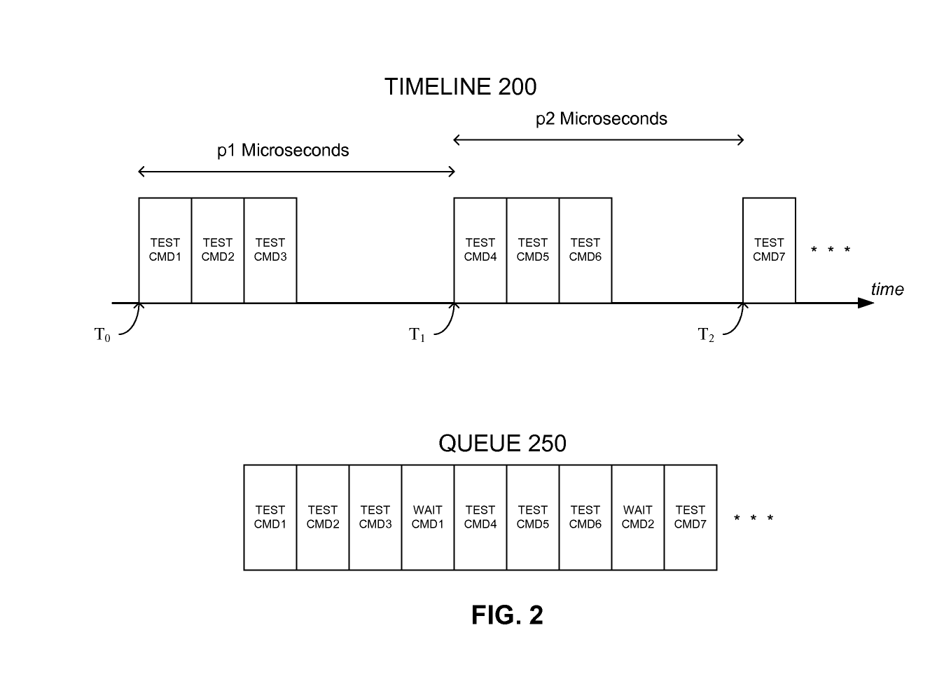

Recall that the queued commands may include various timeline definition and control commands. Here, we focus on one such command: a “wait” command. In a variant, a parameter of the wait command defines how long the DUT waits from a particular system time until proceeding to the next command in the queue. The system time from which the waiting period is measured is the later of (1) the beginning of the command sequence, or (2) the point in time defined by the immediately preceding wait command. This is illustrated in FIG. 2. For this example, the commands in the queue 250 include, in order, test commands 1-3, wait command 1, test commands 4-6, wait command 2, and test command 7. Note that each of the commands may be accompanied by one or more parameters of the command.

The execution of the commands in this example is according to timeline 200. It begins in response to receipt of an instruction to execute the command queue, which may cause the start time T₀ (the current system time at the beginning of the test sequence) to be recorded. Execution then proceeds to test commands 1, 2, and 3, in order. Each of these commands is automatically executed, for example, upon completion of the immediately preceding command. Thus, test command 2 is executed in response to the completion of test command 1, and test command 3 is executed in response to completion of test command 2. While the precise length of time consumed by the execution of each of the test commands may not be known in advance, it may be estimated. Each of these and other test commands may take a different amount of time.

After completion of test command 3, wait command 1 is executed. A parameter value p1 of this command is a length of time to wait. The parameter may be set in microseconds or other units. In this case, the waiting period starts at system time T₀, because there are no preceding wait commands. The parameter of wait command 1 may be selected so that the wait period is longer than the combined conservative estimates of the periods of time required for completion of test commands 1-3. This guarantees (absent some unexpected error) that the next test command, i.e., test command 4, begins only after test command 3 completes. It also guarantees that test command 4 begins at a time known in advance. Note that wait time p1 may be made longer (possibly much longer) than the time conservatively needed for test commands 1-3. For example, test command 3 may be a trigger for the DUT to transmit an RF waveform for measuring by the equipment 110, and the equipment 110 may need some time to perform the measurement. Wait command 1 may be made long enough to cover the time for performing test commands 1-3, conservatively estimated, plus the time that the equipment 110 needs to make the test measurement.

In response to the completion of wait command 1 at a time T₁ (expiration of the period defined by the parameter p1 of wait command 1), test commands 4-6 are executed in order, followed by wait command 2. Wait command 2 includes a parameter value p2 that defines the length of the associated waiting period. The waiting period associated with wait command 2 begins at system time T₁, because this is the time of expiration of the immediately preceding wait command 1. In a manner similar to the case of wait command 1, the waiting period of wait command 2 may be made longer than the combined conservative estimates of times needed for completion of test commands 4-6. The waiting period p2 may be lengthened further to accommodate the need of the equipment 110, or for other reasons.

When the waiting period of wait command 2 expires, test command 7 is executed.

As can be seen, the configuration of the DUT can be set and made predictable at specific times, defining the timeline of the DUT's testing. Without the wait commands (or their analogues or functional equivalents), the test commands would be executed one after the other. Because of the uncertainty in the length of time each test command takes, it would be difficult to set the DUT into predefined configurations at specific times. Further, dwelling times in the predefined configuration can be lengthened through the use of the wait commands, enabling easier synchronization between and among the equipment 110, the processing device 120, and the DUT.

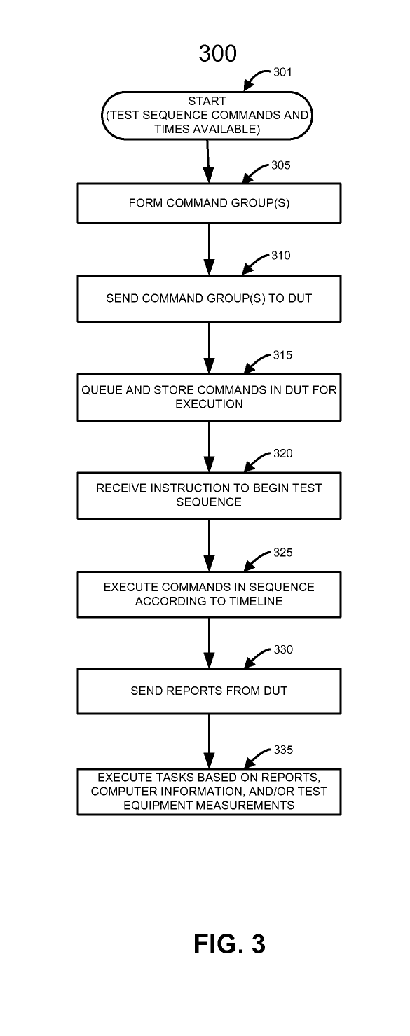

FIG. 3 illustrates selected steps of a process 300 for testing a DUT. At flow point 301, a test sequence for the DUT is available in the form of a plurality of test commands and wait commands; the wait commands may include time parameters, or the time parameters may inhere in the wait commands. The test commands may be based on the test criteria and test equipment (such as the equipment 110) connected to the DUT. The placement of the wait commands and their time parameters may be designed to match the measurements made by the test equipment with the state/configuration of the DUT. The placement of the wait commands and their time parameters may also be designed to match the stimuli provided by the test equipment with the state/configuration of the DUT (including reading of the DUT's internal measurements).

In step 305, a computer (such as the processing block 120) combines the individual commands into command groups (or group, as the case may be), with multiple commands per command group.

In step 310, the computer sends to the DUT the command groups or group formed in the preceding step 305. The group commands are received by a DUT block analogous to the FTM Core Task Dispatcher of FIG. 1.

In step 315, the DUT queues for execution the individual commands in the received command groups. This may be done by a DUT block analogous to the FTM Core Sequencer of FIG. 1.

In step 320, the DUT receives an instruction to begin execution of the test sequence. The instruction may be sent from the computer.

In step 325, the DUT executes the commands in sequence and according to the timeline defined by the wait commands. This may be done by blocks that include those analogous to the FTM Core Sequencer and FTM Technology Dispatcher of FIG. 1.

In step 330, the DUT sends to the computer reports with status of the test commands.

In step 335, the computer performs testing tasks based on the reports, information stored on the computer, and measurements received from the test equipment. These tasks may include outputting test results, such as pass/fail information and actual measurements. For example, the results can be output in visual form (display, printer), as sound indications, by transmission of corresponding signals, or marking the DUT (directly or indirectly) so that the DUT can be associated with the test results. For example, a record of DUT passing, DUT failing, and/or actual measurements made on the DUT may be made in a table location corresponding to the DUT; the table may be stored in a tangible medium. The tasks can also include calibration of the DUT, such as by writing certain data derived from measurement results into a non-volatile memory of the DUT. For example, transmit power levels of the DUT may be calibrated based on the measurements made by the test equipment, by writing information into the DUT's EEPROM.

The process 300 may continue with additional commands. The process 300 may also be repeated as needed, for the same DUT or other DUTs.

Although steps and/or decisions of various methods may have been described serially in this disclosure, some of these steps and decisions may be performed by separate elements in conjunction or in parallel, asynchronously or synchronously, in a pipelined manner, or otherwise. In particular, all or portions of the steps 325, 330, and 335 may be performed in parallel. More generally, there is no particular requirement that the steps and decisions be performed in the same order in which this description lists them and the accompanying Figures show them, except where explicitly so indicated, otherwise made clear from the context, or inherently required. It should be noted, however, that in selected variants the steps and decisions are performed in the particular progressions described above and/or shown in the accompanying Figures. Furthermore, not every illustrated step and decision may be required in every embodiment, while some steps and decisions that have not been specifically illustrated may be desirable in some embodiments.

Those of skill in the art would understand, after perusal of this document, that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a terminal. In an alternative, the processor and the storage medium may reside as discrete components in a terminal.

The methodologies disclosed herein are capable of being stored on an article of manufacture, for example, to facilitate transporting and transferring such methodologies to computers. The term article of manufacture, as used herein, is intended to encompass a computer program accessible from a computer-readable device, carrier, or media.

The previous description of the disclosed embodiments and variants is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments and variants shown herein, but is to be accorded the widest scope consistent with the principles and novel features disclosed herein.

Therefore, the present invention is not to be limited except in accordance with the claims.

What is claimed is:

1. A method of testing an electronic device, the method comprising steps of:
sending to the electronic device a test sequence of the electronic device, the test sequence comprising a plurality of N test commands CTEST[i], 1≦i≦N, and one or more timeline definition commands CWAIT[j], 1≦j≦M, M being one or more, the one or more timeline definition commands defining a timeline for executing the test sequence;
transferring to the electronic device an instruction to execute the test sequence; and
configuring the electronic device to:
receive the plurality of N test commands and the one or more timeline definition commands,
queue in order the plurality of N test commands and the one or more timeline definition commands received by the electronic device, to obtain a queue of commands,
abstain from executing the queue of commands until the electronic device receives the instruction to execute the test sequence,
when executing the queue of commands, execute each timeline definition command CWAIT[j] by preventing execution of the test command immediately following said each timeline definition command CWAIT[j] until a time t[j] associated with said each timeline definition command CWAIT[j], the time t[j] being defined by expiration of a period p[j] associated with said each timeline definition command CWAIT[j], a length L[j] of the period p[j] being defined by said each timeline definition command CWAIT[j], the period p[j] for the earliest timeline definition command in the queue starting at system time at the beginning of execution of the test sequence, the period p[j] for all timeline definition commands in the queue other than the earliest timeline definition command in the queue starting at a time t[j−1] associated with timeline definition command CWAIT[j−1] that immediately precedes said each timeline definition command CWAIT[j],
receive the instruction, and
in response to receiving the instruction, execute the queue of commands in order and according to the timeline.

2. A method according to claim 1, wherein the step of sending comprises:
forming one or more group commands from the plurality of N test commands and the one or more timeline definition commands, each group command of the one or more group commands comprising a plurality of commands;
transmitting said each group command to the electronic device over an interface of the electronic device.

3. A method according to claim 2, wherein said each timeline definition command CWAIT[j] includes a parameter setting L[j].

4. A method according to claim 3, wherein all test commands in the queue preceding said each timeline definition command CWAIT[j] are expected to complete no later than t[j].

5. A method according to claim 3, wherein the electronic device is further configured to block at least some messages through the interface during execution of the test sequence.

6. A method according to claim 3, further comprising configuring the electronic device to report status of execution of each test command in the queue.

7. A method according to claim 3, wherein the electronic device is further configured to block all messages through the interface during execution of the test sequence, except messages requesting status and messages reporting status.

8. A method according to claim 3, wherein the electronic device is further configured to block all messages through the interface during execution of the test sequence, except messages requesting status of execution of the commands in the queue and messages reporting status of execution of the commands in the queue.

9. A method according to claim 3, further comprising a step for reducing interference with the electronic device during execution of the test sequence.

10. A method according to claim 8, wherein the steps of sending and transferring are performed by a computer connected to the electronic device through the interface, the electronic device is a mobile device, and the interface is a Universal Serial Bus (USB) interface.

11. A method according to claim 3, wherein the steps of sending and transferring are performed by a computer connected to the electronic device through the interface, the computer is connected to the test equipment, the test equipment is connected to the electronic device, the method further comprising:
determining at least some timeline definition commands of the one or more timeline definition commands to match in time a measurement of the test equipment with a state of the electronic device.

12. A method according to claim 3, wherein the steps of sending and transferring are performed by a computer connected to the electronic device through the interface, the computer is connected to the test equipment, the test equipment is connected to the electronic device, the method further comprising:
determining at least some timeline definition commands of the one or more timeline definition commands to match in time a state of the test equipment with a measurement of the electronic device.

13. A method according to claim 3, wherein the steps of sending and transferring are performed by a computer connected to the electronic device through the interface, the computer is connected to the test equipment, the test equipment is connected to the electronic device, the electronic device is a mobile device comprising a radio frequency (RF) receiver, the test equipment comprises an RF generator, the method further comprising:
determining at least some timeline definition commands of the one or more timeline definition commands to match in time a measurement made by the RF receiver of the electronic device with a state of the RF generator.

14. A method according to claim 3, wherein the steps of sending and transferring are performed by a computer connected to the electronic device through the interface, the computer is connected to the test equipment, the test equipment is connected to the electronic device, the electronic device is a mobile device comprising a radio frequency (RF) transmitter, the test equipment comprises an RF analyzer, the method further comprising:
determining at least some timeline definition commands of the one or more timeline definition commands to match in time a measurement made by the RF analyzer with a state of the RF transmitter.

15. A method according to claim 3, wherein the steps of sending and transferring are performed by a computer connected to the electronic device through the interface, the computer is connected to the test equipment, the test equipment is connected to the electronic device, the method further comprising:
determining at least some timeline definition commands of the one or more timeline definition commands to match in time a state of the test equipment with a state of the electronic device.

16. A method according to claim 15, further comprising:
calibrating the electronic device in accordance with one or more test results of the test sequence.

17. A method according to claim 15, further comprising:
recording one or more test results of the test sequence in a location corresponding to the electronic device.

18. A method according to claim 15, further comprising:
outputting one or more test results of the test sequence.

19. A method according to claim 2, wherein each test command of the plurality of N test commands is less than 400 bytes in length, and each command group of the one or more command groups is no longer than two kilobytes in length.

20. A method of testing an electronic device, the method comprising steps of:
step for sending to the electronic device a test sequence of the electronic device;
after the step for sending, triggering transferring execution of the test sequence;
step for executing the test sequence in accordance with a predefined timeline.

21. An electronic device configured to:
receive a test sequence of the electronic device, the test sequence comprising a plurality of N test commands CTEST[i], 1≦i≦N, and one or more timeline definition commands CWAIT[j], 1≦j≦M, M being one or more, the one or more timeline definition commands defining a timeline for executing the test sequence;
after receiving all steps of the test sequence, receive an instruction to execute the test sequence;
queue in order the plurality of N test commands and the one or more timeline definition commands received by the electronic device, to obtain a queue of commands;
abstain from executing the queue of commands until the electronic device receives an instruction to execute the test sequence;
when executing the queue of commands, execute each timeline definition command CWAIT[j] by preventing execution of the test command immediately following said each timeline definition command CWAIT[j] until a time t[j] associated with said each timeline definition command CWAIT[j], the time t[j] being defined by expiration of a period p[j] associated with said each timeline definition command CWAIT[j], a length L[j] of the period p[j] being defined by said each timeline definition command CWAIT[j], the period p[j] starting at the later of: (1) system time at the beginning of execution of the test sequence, and (2) time t[j−1] associated with timeline definition command CWAIT[j−1] that immediately precedes said each timeline definition command CWAIT[j];
receive the instruction to execute the test sequence; and
in response to receipt of the instruction, execute the queue of commands in order and according to the timeline.

22. An electronic device according to claim 21, further configured to receive through an interface of the electronic device the test sequence as one or more group commands formed from the plurality of N test commands and the one or more timeline definition commands, each group command of the one or more group commands comprising a plurality of commands.

23. An electronic device according to claim 22, wherein said each timeline definition command CWAIT[j] includes a parameter setting L[j].

24. An electronic device according to claim 23, wherein all test commands in the queue preceding said each timeline definition command CWAIT[j] are expected to complete no later than t[j].

25. An electronic device according to claim 23, wherein the electronic device is further configured to block at least some messages through the interface during execution of the test sequence.

26. An electronic device according to claim 23, further comprising configuring the electronic device to report status of execution of each test command in the queue.

27. An electronic device according to claim 23, wherein the electronic device is further configured to block all messages through the interface during execution of the test sequence, except messages requesting status and messages reporting status.

28. An electronic device according to claim 23, wherein the electronic device is further configured to block all messages through the interface during execution of the test sequence, except messages requesting status of execution of the commands in the queue and messages reporting status of execution of the commands in the queue.

29. An electronic device according to claim 23, wherein the electronic device is further configured to perform a step for reducing interference with the electronic device during execution of the test sequence.

30. An electronic device according to claim 28, wherein the test sequence is received from a computer connected to the electronic device through the interface, the electronic device is a mobile device, and the interface is a Universal Serial Bus (USB) interface.

31. An electronic device according to claim 23, wherein the test sequence is received from a computer connected to the electronic device through the interface, the computer is connected to the test equipment, the test equipment is connected to the electronic device, and at least some timeline definition commands of the one or more timeline definition commands are determined to match in time a measurement of the test equipment with a state of the electronic device.

32. An electronic device according to claim 23, wherein the test sequence is received from a computer connected to the electronic device through the interface, the computer is connected to the test equipment, the test equipment is connected to the electronic device, and at least some timeline definition commands of the one or more timeline definition commands are determined to match in time a state of the test equipment with a measurement of the electronic device.

33. An electronic device according to claim 23, wherein the test sequence is received from a computer connected to the electronic device through the interface, the computer is connected to the test equipment, the test equipment is connected to the electronic device, the electronic device is a mobile device comprising a radio frequency (RF) receiver, the test equipment comprises an RF generator, and at least some timeline definition commands of the one or more timeline definition commands are determined to match in time a measurement made by the RF receiver of the electronic device with a state of the RF generator.

34. An electronic device according to claim 23, wherein the test sequence is received from a computer connected to the electronic device through the interface, the computer is connected to the test equipment, the test equipment is connected to the electronic device, the electronic device is a mobile device comprising a radio frequency (RF) transmitter, the test equipment comprises an RF analyzer, and at least some timeline definition commands of the one or more timeline definition commands are determined to match in time a measurement made by the RF analyzer with a state of the RF transmitter of the electronic device.

35. An electronic device according to claim 23, wherein the test sequence is received from a computer connected to the electronic device through the interface, the computer is connected to the test equipment, the test equipment is connected to the electronic device, and at least some timeline definition commands of the one or more timeline definition commands are determined to match in time a state of the test equipment with a state of the electronic device.

36. An article of manufacture comprising at least one machine readable medium storing instructions for configuring an electronic device to:
receive a test sequence of the electronic device, the test sequence comprising a plurality of N test commands CTEST[i], 1≦i≦N, and one or more timeline definition commands CWAIT[j], 1≦j≦M, M being one or more, the one or more timeline definition commands defining a timeline for executing the test sequence;
queue in order the plurality of N test commands and the one or more timeline definition commands received by the electronic, to obtain a queue of commands;
when executing the queue of commands, execute each timeline definition command CWAIT[j] by preventing execution of the test command immediately following said each timeline definition command CWAIT[j] until a time t[j] associated with said each timeline definition command CWAIT[j], the time t[j] being defined by expiration of a period p[j] associated with said each timeline definition command CWAIT[j], a length L[j] of the period p[j] being defined by said each timeline definition command CWAIT[j], the period p[j] for the earliest timeline definition command in the queue starting at system time at the beginning of execution of the test sequence, the period p[j] for all timeline definition commands in the queue other than the earliest timeline definition command in the queue starting at a time t[j−1] associated with timeline definition command CWAIT[j−1] that immediately precedes said each timeline definition command CWAIT[j]; and
after receiving and queueing all commands of the test sequence, execute the queue of commands in order and according to the timeline.

37. An electronic device comprising:
means for receiving a test sequence of the electronic device, the test sequence comprising a plurality of N test commands CTEST[i], 1≦i≦N, and one or more timeline definition commands CWAIT[j], 1≦j≦M, M being one or more, the one or more timeline definition commands defining a timeline for executing the test sequence;
means for queueing in order the plurality of N test commands and the one or more timeline definition commands received by the electronic device, to obtain a queue of commands;
means for executing each timeline definition command CWAIT[j] by preventing execution of the test command immediately following said each timeline definition command CWAIT[j] until a time t[j] associated with said each timeline definition command CWAIT[j], the time t[j] being defined by expiration of a period p[j] associated with said each timeline definition command CWAIT[j],], a length L[j] of the period p[j] being defined by said each timeline definition command CWAIT[j], the period p[j] for the earliest timeline definition command in the queue starting at system time at the beginning of execution of the test sequence, the period p[j] for all timeline definition commands in the queue other than the earliest timeline definition command in the queue starting at a time t[j−1] associated with timeline definition command CWAIT[j−1] that immediately precedes said each timeline definition command CWAIT[j];
means for executing the queue of commands in order and according to the timeline, in response to receipt of an instruction to execute the test sequence, after receiving and queueing the test sequence.
